(19) United States
(12) Patent Application Publication
(10) Pub. No.: US 2017/0355107 A1
(43) Pub. Date: Dec. 14, 2017

(54) METHODS FOR MAKING INFLATABLE INTERIOR PANEL ARRANGEMENTS FOR MOTOR VEHICLES

(71) Applicant: Faurecia Interior Systems, Inc., Auburn Hills, MI (US)

(72) Inventor: Maxime SALANDRE, Auburn Hills, MI (US)

(21) Appl. No.: 15/177,361

(22) Filed: Jun. 9, 2016

(51) Int. Cl. B29C 41/22; B29C 41/04; B29C 41/18; B29C 41/46; B29L 31/30; B29K 101/12; B29L 22/02; B29K 105/00

(52) U.S. Cl. CPC B29C 41/22; B29C 41/18; B29C 41/042; B29C 41/46; B29K 2101/12; B29K 2995/0082; B29L 2022/025; B29K 2105/0058; B29L 2031/3038

(57) ABSTRACT

Methods for making inflatable interior panel arrangements for motor vehicles are provided. In one example, a method for making inflatable interior panel arrangement for a motor vehicle includes introducing a molding material into a molding tool that has tooling surfaces. The molding material is contacted with a first tooling surface of the tooling surfaces having a tooling surface temperature different than tooling surface tempe. The molding tool is closed such that the tooling surfaces define a substantially enclosed cavity in the molding tool. An inflatable interior panel is formed comprising rotating the molding tool to cover the tooling surfaces of the substantially enclosed cavity with the molding material. The inflatable interior panel comprises an inflatable bladder section and an outer panel section that is integrally coupled to the inflatable bladder section and that has a panel portion stiffness greater than a bladder portion stiffness of the inflatable bladder section.

### TECHNICAL FIELD

The technical field relates generally to interior panels for motor vehicles, and more particularly, the technical field relates to methods for making inflatable interior panel arrangements, such as inflatable knee bolsters or the like, for motor vehicles.

### BACKGROUND

Automobile manufactures prioritize the development and incorporation of safety systems into motor vehicles to help protect occupants during various types of collisions. The seatbelt, which helps to keep occupants secured within their seats, continues to be the primary safety device used in the automotive industry.

Additional safety devices, and in particular inflatable occupant restraint systems or airbag systems are known to enhance the effectiveness of seatbelts in protecting a vehicle occupant during a protection. The traditional frontal airbag is disposed in the steering wheel or the instrument panel of the motor vehicle and acts to protect the head, chest, and pelvic area of a front occupant during a sudden deceleration caused, for example, by an accident. During such an event, however, the lower torso of the occupant may slide forward on the seat of the vehicle especially if a seatbelt is not wom by the occupant. It is known to provide a restraint device, which is commonly referred to as a “knee blocker” or “knee bolster,” to limit this type of movement.

In one knee bolster device described in U.S. Pat. No. 6,302,437 issued to Marriott, an interior vehicle outer panel is operatively coupled to an airbag that is inflatable by a gas source (e.g., gas inflator). During inflation of the airbag, the outer panel is directed towards the lower extremities of an occupant to aid in limiting lower torso translation forward along the vehicle seat. The knee bolster device may be formed, for example, by injection molding the outer panel. The airbag is then coupled to the outer panel during a secondary fastening and/or joining operation(s) by mechanical means. Unfortunately, such secondary fastening and/or joining operations, which can include, for example, additional parts, such as fasteners, brackets, and the like, as well as additional labor, robots, and/or fixtures for forming the device after injection molding or otherwise after forming the outer panel, are relatively expensive and can include significant investment and/or operating costs.

Commonly assigned U.S. patent application Ser. No. 14/920,215 filed Oct. 22, 2015; Attorney Docket No. 109-0030: entitled “Methods for Making Inflatable Interior Panel Arrangements For Motor Vehicles”, the disclosure of which is hereby expressly incorporated herein for all purposes, describes methods of making inflatable interior panels that provide an inflatable bladder section and an outer panel section that are integrally coupled to the inflatable bladder section and that have a panel portion stiffness greater than a bladder portion stiffness of the inflatable bladder section.

Accordingly, it is desirable to provide methods for making inflatable interior vehicle panel devices for motor vehicles with improved manufacturing efficiencies and/or lower manufacturing costs. Furthermore, other desirable features and characteristics of the present disclosure will become apparent from the subsequent detailed description and the appended claims, taken in conjunction with the accompanying drawings and this background.

### BRIEF SUMMARY

Methods for making inflatable interior panel arrangements for motor vehicles are provided herein. In accordance with an exemplary embodiment, a method for making inflatable interior panel arrangement for a motor vehicle includes, but is not limited to, introducing a molding material into a molding tool that has tooling surfaces. The molding material is first deposited over a tooling surface associated with a first portion of the molding tool controlled to a first tooling surface temperature while remaining tooling surfaces are maintained at a second tooling surface temperature, different than the first tooling surface temperature. The molding tool is advanced to a closed configuration such that the tooling surfaces define a substantially enclosed cavity in the molding tool. An inflatable interior panel is formed comprising rotating the molding tool to cover the tooling surfaces of the substantially enclosed cavity with the molding material. The inflatable interior panel comprises an inflatable bladder section and an outer panel section that is integrally coupled to the inflatable bladder section and that has a panel portion stiffness greater than a bladder portion stiffness of the inflatable bladder section.

In a second exemplary embodiment, and a method for making inflatable interior panel arrangement for a motor vehicle includes, but is not limited to, preparing a molding tool having a first tooling surface and a second tooling surface so that the first tooling surface is at a temperature different than a temperature of the second tooling surface. The method further includes, but is not limited to, introducing a molding material into the molding tool. The method further includes, but is not limited to, advancing the molding tool to a closed configuration such that the tooling surfaces define a substantially enclosed cavity in the molding tool. The method still further includes, but is not limited to, forming an inflatable interior panel by rotating the molding tool to cover the tooling surfaces of the substantially enclosed cavity with the molding material. An outer panel section is formed on the first tooling surface and an inflatable bladder portion is formed on the second tooling surface and the outer panel section has a stiffness greater than a bladder portion stiffness and the outer panel section is integrally coupled to the inflatable bladder section.

### BRIEF DESCRIPTION OF THE DRAWINGS

The various embodiments will hereinafter be described in conjunction with the following drawing figures, wherein like numerals denote like elements, and wherein:

FIGS. 1-6 illustrate, in cross-sectional views, methods for making inflatable interior panel arrangements during various fabrication stages in accordance with an exemplary embodiment.

FIG. 7 illustrates an inflatable interior panel in accordance with herein described embodiments.

### DETAILED DESCRIPTION

The The following Detailed Description is merely exemplary in nature and is not intended to limit the various embodiments or the application and uses thereof. Furthermore, there is no intention to be bound by any theory presented in the preceding background or the following detailed description.

Various embodiments contemplated herein relate to methods for making inflatable interior panel arrangements for motor vehicles. The exemplary embodiments taught herein introduce molding material into a molding tool that has tooling surfaces. In an exemplary embodiment, the molding material is first deposited over a tooling surface associated with a first portion of the molding tool controlled to a first tooling surface temperature while remaining tooling surfaces are maintained at a second tooling surface temperature, different than the first tooling surface temperature.

The molding tool is advanced to a closed configuration such that the tooling surfaces define a substantially enclosed cavity in the molding tool. In one example, the molding tool includes the first portion and a second portion that are matched mold portions and that are advanced towards each other to the closed configuration. In the closed configuration, the tooling surfaces associated with each of the first and second portions together defined the substantially enclosed cavity. In an exemplary embodiment, the molding tool is part of a rotational molding process and is rotated in the closed configuration to move at least a portion of the second molding material over the tooling surfaces associated with the second portion of the molding tool while at least a portion of the first molding material remains over the tooling surfaces associated with the first portion of the molding tool. As such, the tooling surfaces of the substantially enclosed cavity are cooperatively covered with the molding material.

In an exemplary embodiment, the molding material is a slush phase, but alternatively may be liquid phase, powered phase and/or molten before introduction into the molding tool. Still further alternatively, the molding material may be multi-component including, for example, a first molding material and a second molding material. In such case, the first molding material and the second molding material are, independently, in a slush phase, a powdered phase, a liquid phase and/or a molten condition or combinations thereof before and/or during rotation of the molding tool to facilitate covering the tooling surfaces of the substantially enclosed cavity.

In accordance with an exemplary embodiment, the first tooling surface is maintained to a first tooling surface temperature such that a portion of the molding material upon deposition on the first tooling surface is at least partially solidified to form a first solidified molded material prior to further processing. The first molded material and the remaining molding material is subsequently solidified to form a complete inflatable interior panel corresponding to the shape of the substantially enclosed cavity.

In an exemplary embodiment, the inflatable interior panel includes an outer panel section that comprises the first solidified molded material and an inflatable bladder section that comprises the remaining solidified molded material. The outer panel section is integrally coupled to the inflatable bladder section and is stiffer than the inflatable bladder section. Advantageously, in an exemplary embodiment, the relatively more flexible (i.e., less stiff) inflatable bladder section allows the bladder section to be effectively inflated by, for example, a gas inflator, to move the relatively more rigid (i.e., more stiff) outer panel section towards the lower extremities of a vehicle occupant during a crash event to aid in limiting lower torso translation of the occupant forward along the vehicle seat. Moreover, advantageously, in an exemplary embodiment, by forming both the outer panel section and the inflatable bladder section together during the same rotational molding process, the outer panel section and the inflatable bladder section can be coupled together without requiring any secondary joining and/or fastening operations to thereby improve manufacturing efficiencies and/or lower manufacturing costs.

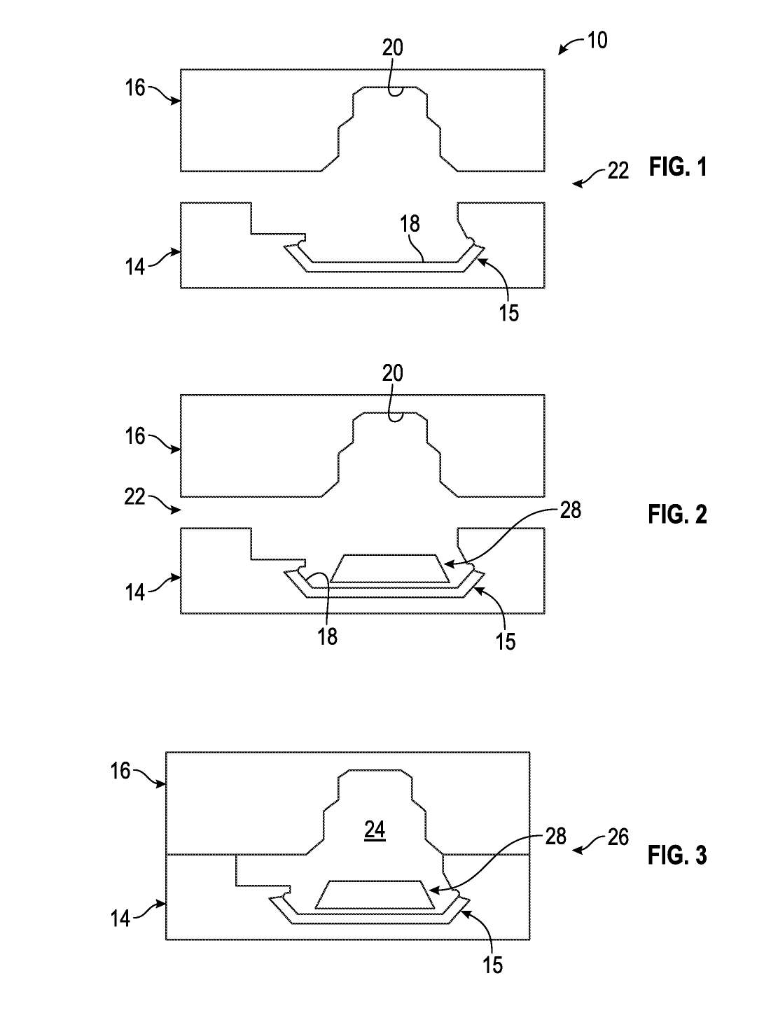

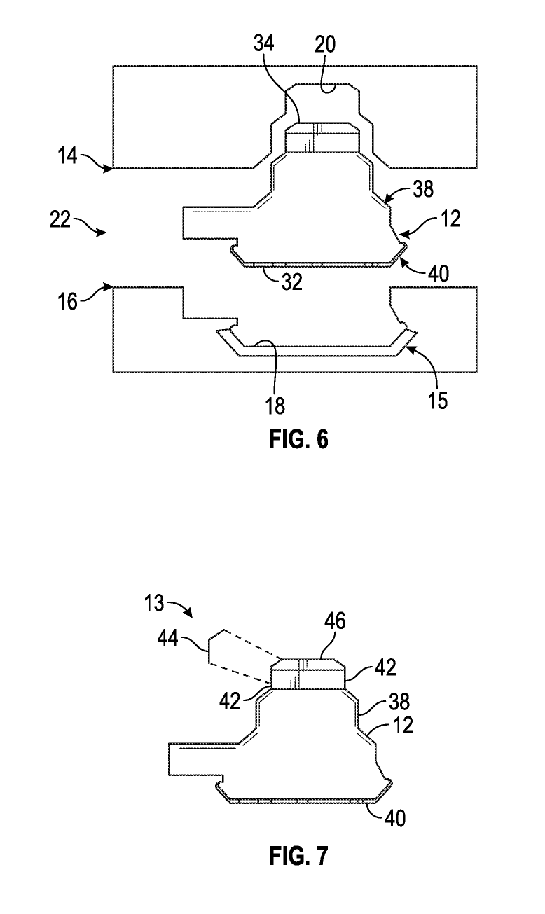

FIG. 1 is a sectional view of a molding tool 10 used in a rotational molding process (discussed in further detail below) for fabricating an inflatable interior panel 12 (shown in FIG. 6) of an inflatable interior panel arrangement 13 (shown in FIG. 7) in accordance with an exemplary embodiment. The molding tool 10 includes molding tool portions 14 and 16 that may be moved relative to each other during the rotational molding process as is well-known in the art. The molding tool portions 14 and 16 are a match die set each having first tooling surface 18 and second tooling surface 20. The tooling surfaces 18 and 20 are accessible when the molding tool 10 is in an open configuration 22 (i.e., the molding tool portions 14 and 16 are spaced apart) as illustrated in FIG. 1, and define a substantially enclosed cavity 24 when the molding tool 10 is in a closed configuration 26 (i.e., the molding tool portions 14 and 16 are positioned in contact with each other) as illustrated in FIG. 3.

Within the tool portion 14 and adjacent the first tooling surface 18, the tool portion 14 is formed with a temperature shell 15. The temperature shell 15 may include a fluid circuit or a portion(s) of a fluid circuit (not shown) that contains a heat transfer fluid (e.g., water, air, oil, or the like) and that is in fluid communication with a heating and/or cooling device (e.g., thermolator, heat exchanger, or the like) for regulating the temperature of the first tooling surface 18. In exemplary embodiments, the first tooling surface 18 may be cooled relative to second tooling surface 20 to be at a predetermined temperature less than the temperature of the second tooling surface 20. In other exemplary embodiments, the first tooling surface may be heated relative to the second tooling surface 20 to be at a predetermined temperature greater than the temperature of the second tooling surface 20. The temperature of the first tooling surface less than or greater than the second tooling is selected in exemplary embodiments based upon the molding material.

In further exemplary embodiments, the entire molding tool 10 is configured to be heated and/or cooled as part of the rotational molding process to maintain the second tooling surfaces 20 at a temperature different than the temperature of the first tooling surface 18, which is maintained by temperature shell 15. For example, the molding tool portions 14 and 16 may independently include a fluid circuit or a portion(s) of a fluid circuit (not shown) that contains a heat transfer fluid (e.g., water, air, oil, or the like) and that is in fluid communication with a heating and/or cooling device (e.g., thermolator, heat exchanger, or the like) for regulating the temperature of the molding tool portions 14 and 16.

Referring to FIG. 2, molding material 28 is introduced to the molding tool 10 and onto the first tooling surface 18. Nonlimiting examples of materials suitable for the molding material 28 include polyurethanes, polyurethane prepolymers, thermoplastic polyurethanes (TPU), thermoplastic polyolefins (TPO), polypropylene, epoxies, epoxy urethane blends, combinations thereof, and the like. In an exemplary embodiment, the molding material 28 includes a curable polymeric precursor such as a polyester polyol(s), polyether polyol(s), or the like and a hardener such as an isocyanate (e.g., block or unblock isocyanate(s)). In an exemplary embodiment, the molding material 28 is deposited overlying the first tooling surface 18 of the molding tool portion 14 in a slush form. Advantageously, in an exemplary embodiment, applying the molding material 28 in slush form onto the first tooling surface 18 facilitates a portion (not depicted) of the molding material 28 spatially conforming to match the first tooling surface 18 and solidifying into the first solidified molded material 32. Alternatively, the molding material 28 may be deposited overlying the first tooling surface 18 of the molding tool portion 14 in a liquid phase, a solid phase or powder form.

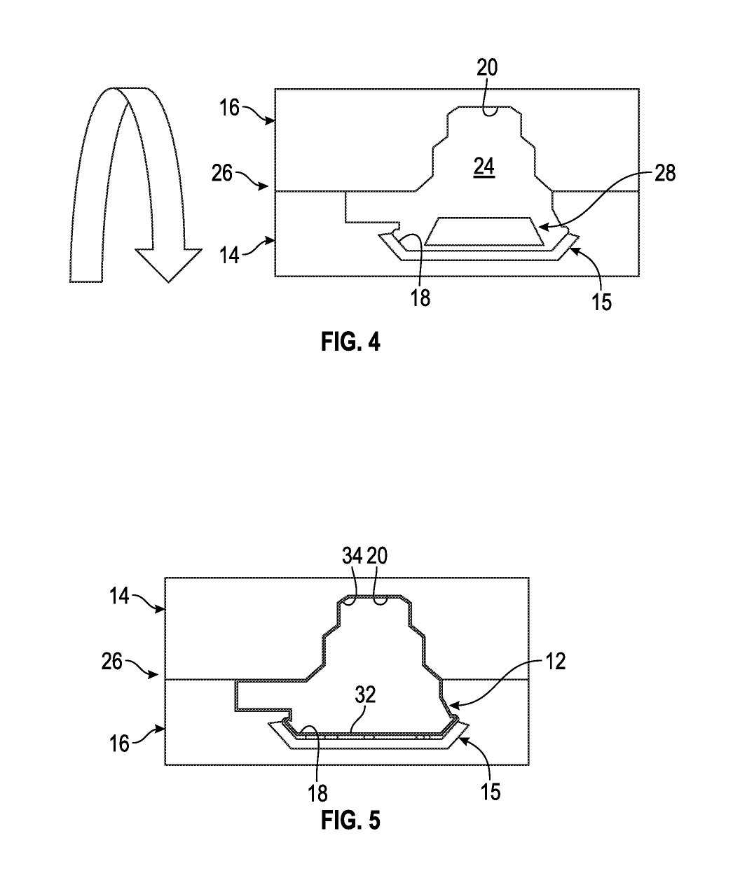

Referring to FIG. 3, the molding tool portions 14 and 16 are advanced towards each other to the closed configuration 26 and the tooling surfaces 18 and 20 together define the substantially enclosed cavity 24. The process continues as illustrated in FIGS. 4-5 by rotating the molding tool 10 as part of the rotational molding process to move at least a second portion of the molding material 28 onto and/or over the tooling surfaces 20 of the molding tool portion 16 forming a second solidified molded material 34. In an exemplary embodiment, at least the portion of the molding material 28 (e.g., either in the molten condition or cured solid form as first solidified molded material 32) that has formed the first solidified molded material 32 remains on and/or over the tooling surfaces 18 of the molding tool portion 14. As such, the tooling surfaces 18 and 20 are substantially completely covered by the molding material 28 solidified as first solidified molded material 32 and second solidified molded material 34.

Further and as discussed above, the mold tooling portions 14 and 16 may be configured for heating and/or cooling, while the shell 15 is configured to maintain the first tooling surface 18 to a predetermined temperature relative to the remainder of the tooling portions 14 and 16 and/or the second tooling surfaces 20. In an exemplary embodiment, the the molding tool portions 14 and 16 are heated to a temperature of from about 100 to about 200° C. during the initial stages of rotating the molding tool 10, while the shell 15 maintains the first tooling surface from 10 to about 50° C. cooler than second tooling surface 20. In an exemplary embodiment, the molding material 28 is a TPO in slush form and, upon contact with the first tooling surfaces 18, conforms to the first tooling surface 18 and a portion thereof solidifies. Next, during the latter stages of rotating the molding tool 10, the molding tool portions 14 and 16 may be cooled to help solidify the molding material 28 to thereby form the inflatable interior panel 36. In an exemplary embodiment, the molding tool portions 14 and 16 are cooled to a temperature of from about 20 to about 80° C. Alternatively, in the embodiment in which the molding material 28 is a thermosetting material, the molding material 28 may be in a liquid form during the initial stages of rotating the molding tool 10. As such, when the molding material 28 contacts the heated tooling surfaces 18 and 20, a first portion the molding material 28 cures and solidifies to form the inflatable interior panel 12. Optionally, in this embodiment, during the latter stages of rotating the molding tool 10, the molding tool portions 14 and 16 may be cooled as discussed above.

As illustrated in FIG. 5, the first solidified molded materials 32 and 34 are molded to a shape corresponding to the tooling surfaces 18 and 20 of the substantially enclosed cavity 24 and define the inflatable interior panel 12. In particular, the inflatable panel 12 includes an inflatable bladder section 38, which has a shape that corresponds to the tooling surfaces 20, and an outer panel section 40, which has a shape that corresponds to the tooling surfaces 18 and that is integrally coupled to the inflatable bladder section 38. In an exemplary embodiment, the solidified molded material 32 forms the outer panel section 40, which is relatively stiff or rigid (e.g., relatively high flexural modulus), and the solidified molded material 36 forms the inflatable bladder section 38, which is relatively flexible (e.g., relatively low flexural modulus) and having for example a relatively high elongation. As such, the outer panel section 40 has a panel portion stiffness greater than a bladder portion stiffness of the inflatable bladder section 38. In an exemplary embodiment, the solidified molded material 32 has a flexural modulus of from about 800 to about 1300 MPa or greater than about 1300 MPa at 23° C., and the solidified molded material 34 has a flexural modulus of from about 1 to about 500 MPa and an ultimate elongation of from about 25% to about 500% at 23° C.

The process continues as illustrated in FIG. 6 by advancing the molding tool portions 14 and 16 away from each other to the open configuration 22 to open the substantially enclosed cavity 24 for removing the inflatable interior panel 12 from the molding tool 10. Referring to FIG. 7, an opening 42 is formed in the inflatable bladder section 38 by removing a portion 44 of the inflatable bladder section 38. Next, an inflator 46 is operatively coupled to the inflatable bladder section 38 about the opening 42 to form the inflatable interior panel arrangement 13. In an exemplary embodiment, the portion 44 is removed from the inflatable bladder section 38 using a die cutting operation or the like and the inflator 46 is operatively coupled to the inflatable bladder section using a welding operation. In an exemplary embodiment, the inflator 46 is configured to generate gas to inflate the inflatable bladder section 38 to advantageously move the outer panel section 40 towards the lower extremities of a vehicle occupant during a crash event to aid in limiting lower torso translation of the occupant forward along the vehicle seat.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It being understood that various changes may be made in the function and arrangement of elements described in an exemplary embodiment without departing from the scope of the disclosure as set forth in the appended claims.

What is claimed is:

1. A method for making an inflatable interior panel arrangement for a motor vehicle, the method comprising:
preparing a molding tool having a first tooling surface and a second tooling surface so that the first tooling surface is at a temperature different than a temperature of the second tooling surface;
introducing a molding material into the molding tool;
advancing the molding tool to a closed configuration such that the tooling surfaces define a substantially enclosed cavity in the molding tool; and
forming an inflatable interior panel by rotating the molding tool to cover the tooling surfaces of the substantially enclosed cavity with the molding material, wherein an outer panel section is formed on the first tooling surface and an inflatable bladder portion is formed on the second tooling surface and the outer panel section has a stiffness greater than a bladder portion stiffness and the outer panel section is integrally coupled to the inflatable bladder section.

2. The method of claim 1, wherein introducing a molding material into the molding tool comprises introducing the molding material onto the first tooling surface.

3. The method of claim 1, wherein preparing a molding tool having a first tooling surface and a second tooling surface so that the first tooling surface is at a temperature different than a temperature of the second tooling surface comprises preparing the molding tool so that the first tooling surface has a temperature less than a temperature of the second tooling surface.

4. The method of claim 1, wherein forming an inflatable interior panel by rotating the molding tool to cover the tooling surfaces of the substantially enclosed cavity with the molding material further comprises prior to rotating the molding tool solidifying a portion of the molding material on the first tooling surface to form a first solidified molded material.

5. The method of claim 4, wherein the first solidified molded material has a flexural modulus of from about 800 to about 1300 MPa or greater than about 1300 MPa at 23° C.

6. The method of claim 4, wherein the the outer panel section comprises the first solidified molded material.

7. The method of claim 1, wherein forming an inflatable interior panel by rotating the molding tool to cover the tooling surfaces of the substantially enclosed cavity with the molding material further comprises while rotating the molding tool solidifying a portion of the molding material on the second tooling surface to form a second solidified molded material having a flexural modulus of from about 1 to about 500 MPa at 23° C.

8. The method of claim 7, wherein the second solidified molded material has an ultimate elongation of from about 25% to about 500% at 23° C.

9. The method of claim 7, wherein the inflatable bladder section comprises the second solidified molded material.

10. The method of claim 1, wherein introducing the molding material comprises depositing the molding material as a slush.

11. The method of claim 1, wherein introducing the molding material comprises depositing a molding material that comprises a curable polymeric precursor and a hardener.

12. The method of claim 1, wherein preparing a molding tool having a first tooling surface and a second tooling surface so that the first tooling surface is at a temperature different than a temperature of the second tooling surface comprises cooling the first tooling surface relative to the second tooling surface.

13. The method of claim 1, wherein preparing a molding tool having a first tooling surface and a second tooling surface so that the first tooling surface is at a temperature different than a temperature of the second tooling surface comprises heating the first tooling surface relative to the second tooling surface.

14. The method of claim 1, wherein preparing a molding tool having a first tooling surface and a second tooling surface so that the first tooling surface is at a temperature different than a temperature of the second tooling surface comprises cooling a first tool portion including the first tooling surface and heating a second tool portion including the second tooling surface.

15. The method of claim 1, wherein preparing a molding tool having a first tooling surface and a second tooling surface so that the first tooling surface is at a temperature different than a temperature of the second tooling surface comprises heating a first tool portion including the first tooling surface and a second tool portion including the second tooling surface, and cooling the first tooling surface.

16. The method of claim 1, wherein preparing a molding tool having a first tooling surface and a second tooling surface so that the first tooling surface is at a temperature different than a temperature of the second tooling surface comprises cooling a first tool portion including the first tooling surface and a second tool portion including the second tooling surface, and heating the first tooling surface.
